(19) United States
(12) Patent Application Publication
(10) Pub. No.: US 2020/0310322 A1
(43) Pub. Date: Oct. 1, 2020

(54) SHEET ALIGNING MECHANISM AND IMAGE FORMING APPARATUS

(71) Applicant: TOSHIBA TEC KABUSHIKI KAISHA, Tokyo (JP)

(72) Inventor: Naofumi SOGA, Sunto Shizuoka (JP)

(21) Appl. No.: 16/369,698

(22) Filed: Mar. 29, 2019

(51) Int. Cl. G03G 15/00; B65H 9/00; B65H 5/06

(52) U.S. Cl. CPC G03G 15/6567; B65H 5/062; B65H 9/002

(57) ABSTRACT

A sheet aligning mechanism includes first and second aligning rollers that form a nip therebetween, to which a leading end of a sheet to be aligned is conveyed. The first aligning roller includes first and second roller portions along a rotational axis of the first aligning roller, the first roller portion including a center of the first aligning roller in an axial direction, and a friction coefficient of a surface of the second roller portion is lower than a friction coefficient of a surface of the first roller portion.

### FIELD

Embodiments described herein relate generally to a sheet aligning mechanism and an image forming apparatus.

### BACKGROUND

An image forming apparatus of some types may include an aligning mechanism for aligning a sheet. The aligning mechanism aligns the sheet by causing a leading end of the sheet to contact a nip of aligning rollers.

However, a conventional aligning mechanism may not sufficiently correct the inclination of the sheet.

### DESCRIPTION OF THE DRAWINGS

FIG. 1 illustrates an entire configuration of an image forming system including an image forming apparatus according to an embodiment.

FIG. 2 illustrates a schematic side view of a conveyance unit including a sheet aligning mechanism.

FIG. 3 illustrates a perspective view of the sheet aligning mechanism.

FIG. 4 illustrates a transparent view of a second separated roller.

FIG. 5 illustrates a schematic perspective view of the sheet aligning mechanism.

FIGS. 6 and 7 illustrate plan view of an aligning roller to explain normal aligning.

FIG. 8 illustrates a schematic side view of a conveyance unit including a sheet aligning mechanism.

FIG. 9 illustrates a perspective view of the sheet aligning mechanism according to a modification example of the embodiment.

### DETAILED DESCRIPTION

In general, according to an embodiment, a sheet aligning mechanism includes first and second aligning rollers that form a nip therebetween, to which a leading end of a sheet to be aligned is conveyed. The first aligning roller includes first and second roller portions along a rotational axis of the first aligning roller, the first roller portion including a center of the first aligning roller in an axial direction, and a friction coefficient of a surface of the second roller portion is lower than a friction coefficient of a surface of the first roller portion.

Hereinafter, a sheet aligning mechanism and an image forming apparatus according to an embodiment will be described with reference to the drawings. In each drawing, the same reference numerals are used for the same components. In each drawing, a dimension and a shape of each element may be exaggerated or simplified for easy understanding.

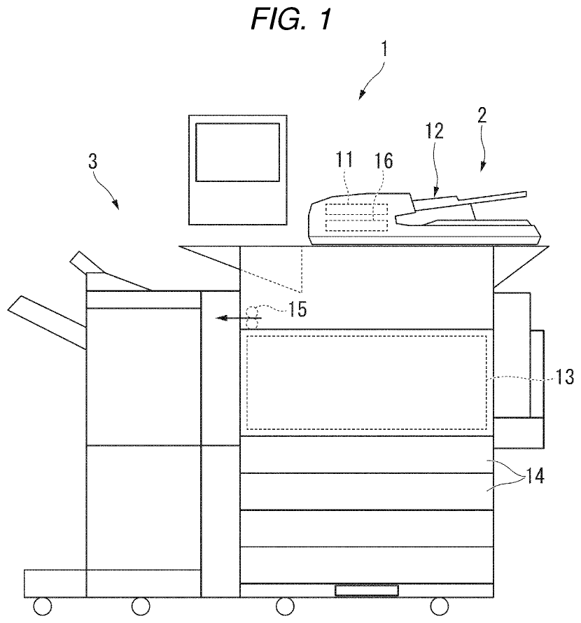

FIG. 1 illustrates a perspective view of an entire configuration of an image forming system 1. As illustrated in FIG. 1, the image forming system 1 includes an image forming apparatus 2 and a post-processing apparatus 3. The image forming apparatus 2 forms an image on a sheet. The post-processing apparatus 3 performs post-processing on the sheet conveyed from the image forming apparatus 2.

The image forming apparatus 2 includes a control panel 11, a scanner unit 12, a printer unit 13, a paper feed unit 13, a paper discharge unit 15, and an image forming control unit 16.

The control panel 11 includes various keys to receive an operation of a user. For example, the control panel 11 receives an input related to a type of post-processing on a sheet. The control panel 11 transmits information regarding the inputted type of the post-processing to the post-processing apparatus 3.

The scanner unit 12 includes a reading unit to read out image information of an object to be copied. The scanner unit 12 transmits the read-out image information to the printer unit 13.

The printer unit 13 forms an output image (hereinafter, referred to as a “toner image”) using developer such as toner, based on the image information transmitted from the scanner unit 12 or an external device. The printer unit 13 transfers the toner image on a surface of the sheet. The printer unit 13 fixes the toner image onto the sheet by applying heat and pressure on the toner image transferred on the sheet.

The paper feed unit 14 supplies sheets to the printer unit 13 one by one (or one copy) in accordance with a timing when the printer unit 13 forms the toner image.

The paper discharge unit 15 conveys the sheet discharged from the printer unit 13 to the post-processing apparatus 3.

The image forming control unit 16 controls an overall operation of the image forming apparatus 2. That is, the image forming control unit 16 controls the control panel 11, the scanner unit 12, the printer unit 13, the paper feed unit 14, and the paper discharge unit 15. The image forming control unit 16 is formed of a control circuit including a CPU, a ROM, and a RAM.

The post-processing apparatus 3 is disposed adjacent to the image forming apparatus 2. The post-processing apparatus 3 executes post-processing specified through the control panel 11, on the sheet conveyed from the image forming apparatus 2. For example, the post-processing is stapling or sorting.

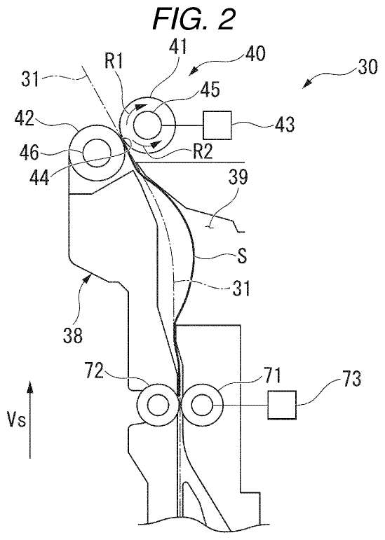

Hereinafter, a conveyance unit will be described. FIG. 2 illustrates a schematic side view of a conveyance unit 30. As illustrated in FIG. 1, the image forming apparatus 2 includes the conveyance unit 30 (conveyance device, see FIG. 2). The image forming apparatus 2 includes a conveyance path 31 (see FIG. 2) for conveying a sheet S.

The sheet S (object to be conveyed) may be one sheet (for example, normal paper), or may be a layered body in which a plurality of sheets overlap one another.

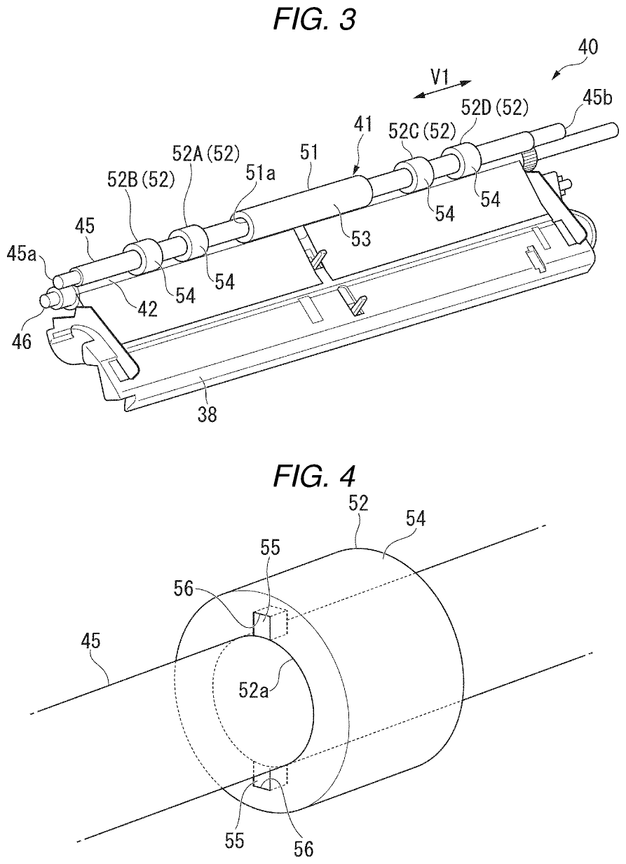

As illustrated in FIG. 2, the conveyance unit 30 includes a conveyance path forming unit 38, a sheet aligning mechanism 40, and a pair of conveyance rollers 71 and 72. The sheet S is conveyed from the bottom to the top along the conveyance path 31. The sheet S is conveyed from the paper feed unit 14 (for example, a paper feed cassette) to the printer unit 13 (for example, an image forming unit) through the conveyance unit 30 (see FIG. 1). The side of the paper feed unit 14 (lower side in the paper face of FIG. 2) in a conveyance direction Vs of the sheet S is referred to as an “upstream side.” The side of the printer unit 13 (upper side in the paper face of FIG. 2) in the conveyance direction Vs is referred to as a “downstream side.” A direction V1 (a depth direction in the paper face of FIG. 2) perpendicular to the conveyance direction Vs in the surface of the sheet S conveyed along the conveyance path 31 is referred to as a “conveyance perpendicular direction V1” (see FIG. 3).

The conveyance path forming unit 38 forms the conveyance path 31 between the paper feed unit 14 (see FIG. 1) and the printer unit 13 (see FIG. 1). The conveyance path forming unit 38 forms a bending space 39 of the sheet S at the upstream side of a pair of aligning rollers 41 and 42. FIG. 2 illustrates a state where the sheet S bends in the bending space 39 since a leading end of the sheet S collides with the pair of aligning rollers 41 and 42.

Hereinafter, the sheet aligning mechanism will be described. As illustrated in FIG. 2, the sheet aligning mechanism 40 includes the pair of aligning rollers 41 and 42, and an aligning motor 43. The pair of aligning rollers 41 and 42 are provided between the pair of conveyance rollers 71 and 72 and the printer unit 13 (see FIG. 1) in the conveyance direction Vs.

The pair of aligning rollers 41 and 42 include a first aligning roller 41 and a second aligning roller 42. The first aligning roller 41 and the second aligning roller 42 contact with each other, thereby forming a nip 44. The sheet aligning mechanism 40 aligns a position of the leading end of the sheet S by causing the sheet S conveyed along the conveyance path 31 to collide with the nip 44. The position of the leading end of the sheet S means a position of a downstream end of the sheet S in the conveyance direction Vs.

The first aligning roller 41 is provided on a first rotary shaft 45. The aligning motor 43 rotationally drives the first aligning roller 41 by rotationally driving the first rotary shaft 45.

The first aligning roller 41 rotates in the clockwise direction (a direction indicated by the arrow R1) (forward rotation) when letting the sheet S pass through the nip 44. The first aligning roller 41 stops or rotates in the counter clockwise direction (direction indicated by the arrow R2) (reverse rotation) when aligning, that is, when the sheet S is brought into contact with the nip 44.

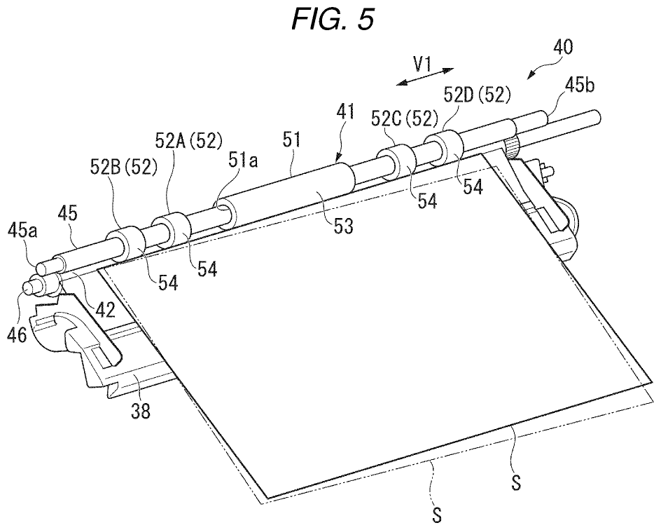

FIG. 3 illustrates a perspective view of the sheet aligning mechanism. FIG. 4 illustrates a transparent view of a second separated roller. As illustrated in FIG. 3, the first aligning roller 41 includes a first separated roller 51 and a plurality of second separated rollers 52. The first separated roller 51 is provided on the first rotary shaft 45. The first separated roller 51 extends in the conveyance perpendicular direction V1. One end of the first rotary shaft 45 is referred to as a first end 45a. The other end of the first rotary shaft 45 is referred to as a second end 45b. The first separated roller 51 rotates along with the first rotary shaft 45. For example, the first separated roller 51 is formed on a portion including a center of the first rotary shaft 45 in a length direction. The first separated roller 51 is also referred to as an intermediate roller 51. An outer circumferential surface of the first separated roller 51 is a first region 53. The first region 53 has a first friction coefficient μ1 with respect to the sheet S (see FIG. 5) in the conveyance direction Vs. The first separated roller 51 is made of rubber (ethylene propylene diene rubber, or the like), resin, or the like. When the first separated roller 51 is made of rubber, the friction coefficient μ1 of the surface increases. For that reason, it is possible to increase a conveyance force when conveying the sheet S (see FIG. 5). The first separated roller 51 includes an insertion hole 51a into which the first rotary shaft 45 is inserted. For example, the first separated roller 51 is fixed to the outer surface of the first rotary shaft 45 with an elastic force thereof.

The second separated rollers 52 are provided on the first rotary shaft 45. The second separated rollers 52 extend in the conveyance perpendicular direction V1. The second separated rollers 52 rotate along with the first rotary shaft 45. The second separated rollers 52 are separate members from the first separated roller 51. When the second separated rollers 52 are separate members from the first separated roller 51, the second separated rollers 52 can be easily mounted on the first rotary shaft 45.

The plurality of second separated rollers 52 are provided on one end side and the other end side of the first rotary shaft 45, respectively, with respect to the first separated roller 51. For example, the plurality of second separated rollers 52 include two second separated rollers 52A and 52B, and two second separated rollers 52C and 52D.

The second separated rollers 52A and 52B are provided on one end side (side of the first end 45a) of the first rotary shaft 45 with respect to the first separated roller 51. The second separated rollers 52A and 52B are provided at different positions in the axis direction of the first rotary shaft 45 in the axis direction. Specifically, the second separated roller 52A is provided on the side of the first end 45a of the first separated roller 51 to be spaced from the first separated roller 51. The second separated roller 52B is provided on the side of the first end 45a of the second separated roller 52A to be spaced from the second separated roller 52A. Since the second separated rollers 52A and 52B are provided at different positions in the axis direction of the first rotary shaft 45, it is easy to cope with aligning of a plurality of types of sheets S (see FIG. 5) having different widths.

The second separated rollers 52C and 52D are provided on the other end side (side of the second end 45b) of the first rotary shaft 45 with respect to the first separated roller 51. The second separated rollers 52C and 52D are provided at different positions of the first rotary shaft 45 in the axis direction. Specifically, the second separated roller 52C is provided on the side of the second end 45b of the first separated roller 51 to be spaced from the first separated roller 51. The second separated roller 52D is provided on the side of the second end 45b of the second separated roller 52C to be spaced from the second separated roller 52C. Since the second separated rollers 52C and 52D are provided at different positions of the first rotary shaft 45 in the axis direction, it is easy to cope with aligning of a plurality of types of sheets S (see FIG. 5) having different widths. The second separated rollers 52 (52A, 52B, 52C, and 52D) are also referred to as end side rollers 52.

Outer circumferential surfaces of the second separated rollers 52 (52A, 52B, 52C, and 52D) are second regions 54. The second region 54 has a second friction coefficient μ2 with respect to the sheet S (see FIG. 5) in the conveyance direction Vs. The second friction coefficient μ2 is lower than the first friction coefficient μ1 of the first region 53. The friction coefficients μ1 and μ2 are static friction coefficients or dynamic friction coefficients. A method of measuring the static friction coefficient and the dynamic friction coefficient is described in ASTM D1894, for example. The second separated rollers 52 are made of resin such as polyacetal (POM), polybutylene terephthalate (PBT), or the like, for example. In particular, polyacetal is desirable since polyacetal has a low surface friction coefficient and is excellent in abrasion resistance. In addition, according to some embodiments, the outer diameter of the second separated rollers 52 are substantially same as that of the first separated roller 51.

In the sheet aligning mechanism 40, the first separated roller 51 is provided at the position including the center of the first rotary shaft 45, and the second separated rollers 52 are provided on one end side and the other end side with respect to the first separated roller 51, respectively. Therefore, the end (end in the conveyance perpendicular direction V1) of the sheet S easily comes into contact with the second separated rollers 52.

It is desirable that the second separated rollers 52 are provided according to a sheet having a predetermined size. For example, according to a sheet with a statement size, the second separated rollers 52A and 52C are provided at positions where corners of the corresponding sheet parallel to the conveyance direction face the second separated rollers 52A and 52C, respectively. In the same way, according to a sheet with a letter size, the second separated rollers 52B and 52D are provided at positions where corners of the corresponding sheet parallel to the conveyance direction face the second separated rollers 52B and 52D, respectively.

As illustrated in FIG. 4, the second separated roller 52 includes an insertion hole 52a into which the first rotary shaft 45 is inserted. A pair of fitting recess portions 56 and 56 (fitted portions) are formed on the inner surface of the insertion hole 52a of the second separated roller 52. Fitting protrusion portions 55 and 55 (fitting portions) of the first rotary shaft 45 are fitted into the fitting recess portions 56 and 56, respectively. Accordingly, the rotation of the second separated roller 52 with respect to the first rotary shaft 45 is regulated. Therefore, the second separated roller 52 rotates along with the first rotary shaft 45. The fitting protrusion portions 55 and 55 are, for example, both ends of a pin inserted into an insertion hole (not illustrated) formed in the first rotary shaft 45.

As illustrated in FIG. 2, the second aligning roller 42 is provided on a second rotary shaft 46. The second aligning roller 42 extends in the conveyance perpendicular direction V1 (see FIG. 3). The second aligning roller 42 is a driven roller which rotates (follow-up rotation) according to the rotation of the first aligning roller 41. The second aligning roller 42 is arranged to face the first aligning roller 41. If the second aligning roller 42 is made of metal (stainless steel, aluminum, or the like), the ability to remove static electricity can be enhanced. The second aligning roller 42 nips the sheet S with the first aligning roller 41 and conveys the sheet S.

The pair of conveyance rollers 71 and 72 are provided at positions on the upstream side of the sheet aligning mechanism 40 in the conveyance direction Vs. The pair of conveyance rollers 71 and 72 include a first conveyance roller 71 and a second conveyance roller 72 which face each other. The first conveyance roller 71 is driven by a motor 73. The second conveyance roller 72 rotates (driven rotation) according to the rotation of the first conveyance roller 71. The pair of conveyance rollers 71 and 72 conveys the sheet S toward the downstream side of the conveyance path 31.

Hereinafter, the movement of a sheet in aligning will be described. First, normal aligning will be described.

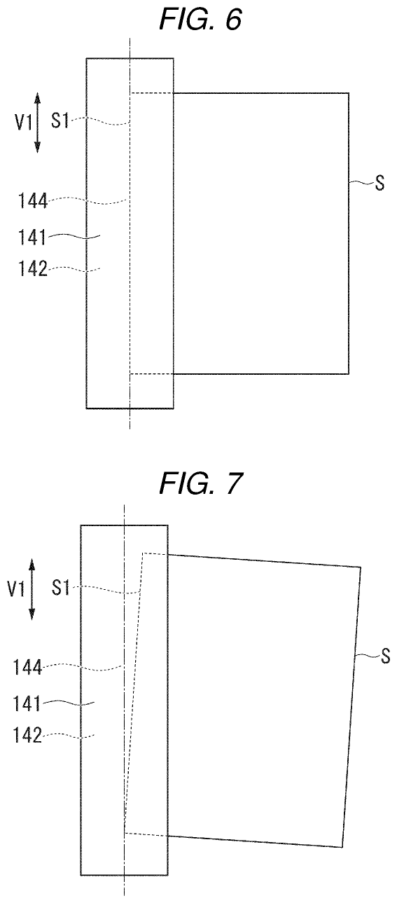

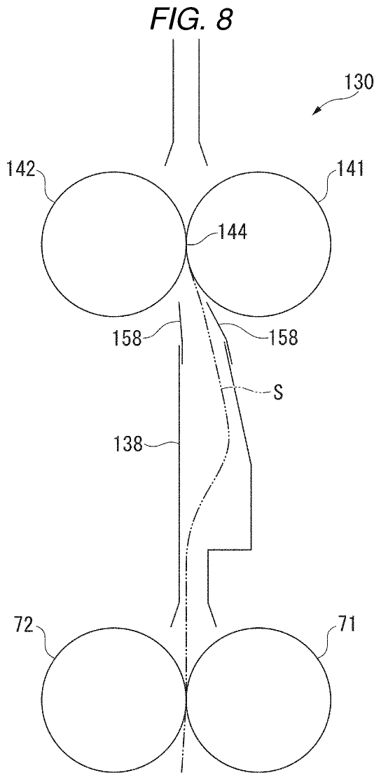

FIGS. 6 and 7 illustrate plan views of normal aligning. FIG. 8 illustrates a schematic side view of a conveyance unit including a sheet aligning mechanism. As illustrated in FIG. 6, in normal aligning, a leading end S1 of a sheet S collides with a nip 144 between a pair of aligning rollers 141 and 142. Accordingly, the pair of aligning rollers 141 and 142 correct the inclination of the sheet S.

However, as illustrated in FIG. 7, the sheet S may not adequately enter between the pair of aligning rollers 141 and 142 due to a positional displacement of the sheet S during conveying, a curl in the leading end portion of the sheet S (curve), or the like, so that the inclination of the sheet S may not be sufficiently corrected.

As illustrated in FIG. 8, a conveyance unit 130 includes a conveyance path forming unit 138, a sheet aligning mechanism 140, and a pair of conveyance rollers 71 and 72. The sheet aligning mechanism 140 includes the pair of aligning rollers 141 and 142. A Mylar® 158 is provided in the conveyance path forming unit 138 to guide the sheet S to the nip 144 between the pair of aligning rollers 141 and 142. However, even if the Mylar 158 is used, the sheet S may not adequately enter between the pair of aligning rollers 141 and 142 as illustrated in FIG. 7, and the inclination of the sheet S may not be sufficiently corrected.

Hereinafter, aligning performed by the sheet aligning mechanism of the embodiment will be described.

FIG. 5 illustrates a perspective view of the sheet aligning mechanism according to the embodiment. As illustrated in FIG. 5, the second separated rollers 52 are provided on end sides of the first separated roller 51 in the sheet aligning mechanism 40 of the embodiment. Therefore, in aligning, the end (end in the conveyance perpendicular direction V1) of the sheet S comes into contact with the second separated rollers 52. Since the friction coefficient of the second separated rollers 52 is lower than the friction coefficient of the first separated roller 51, the sheet S may easily slip. Accordingly, even if a positional displacement of the sheet S during conveying, a curl (curve) of the leading end portion of the sheet S, or the like occurs, the sheet S smoothly enters between the pair of aligning rollers 41 and 42, and collides with the nip 44 as illustrated in FIG. 2. As a result, the inclination of the sheet S can be sufficiently corrected.

After aligning, the pair of aligning rollers 41 and 42 are driven to convey the sheet S in the conveyance direction Vs. Since the friction coefficient of the outer circumferential surface of the first separated roller 51 is high, a conveyance force of the sheet S is high.

Hereinafter, a modification example will be described.

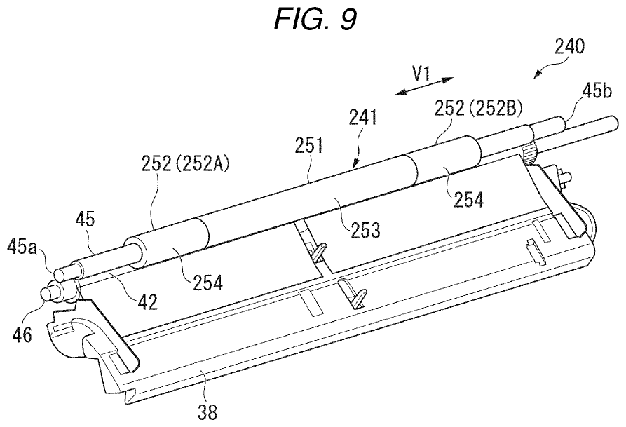

FIG. 9 illustrates a perspective view of a sheet aligning mechanism 240 which is a modification of the sheet aligning mechanism of the embodiment. As illustrated in FIG. 9, the aligning mechanism 240 differs from the sheet aligning mechanism 40 illustrated in FIG. 3 in that the sheet aligning mechanism 240 includes a first aligning roller 241 instead of the first aligning roller 41 (see FIG. 3).

The first aligning roller 241 includes a first separated roller 251 and a pair of second separated rollers 252 and 252. The second separated rollers 252 are provided on one end side and the other end side of the first rotary shaft 45, respectively, with respect to the first separated roller 251. The second separated roller 252, which is provided on the side of the first end 45a of the first separated roller 251, out of the two second separated rollers 252 and 252 is referred to as a second separated roller 252A. The second separated roller 252 provided on the side of the second end 45b of the first separated roller 251 is referred to as a second separated roller 252B. The second separated roller 252A is provided on the side of the first end 45a of the first separated roller 251 in contact with the first separated roller 251 without a gap. The second separated roller 252B is provided on the side of the second end 45b of the first separated roller 251 in contact with the first separated roller 251 without a gap.

An outer circumferential surface of the first separated roller 251 is a first region 253. Outer circumferential surfaces of the second separated rollers 252 (252A and 252B) are second regions 254. A friction coefficient of the second region 254 is lower than a friction coefficient of the first region 253. In addition, according to some embodiments, the outer diameter of the second separated rollers 252 is substantially the same as that of the first separated roller 251.

In the sheet aligning mechanism 240, it is possible to allow the second separated rollers 252 to have a sufficient length since the second separated rollers 252 (252A and 252B) are provided in contact with the first separated roller 251 without a gap. Therefore, the sheet S is more likely to come into contact with the second separated rollers 252. Accordingly, it is possible to sufficiently correct the inclination of the sheet.

A mounting position of the sheet aligning mechanism 40 illustrated in FIG. 2 is not limited to between the paper feed unit 14 and the printer unit 13 (see FIG. 1). The conveyance unit 30 (see FIG. 2) may be provided at any position of the conveyance path in the image forming system (the image forming apparatus and the post-processing apparatus).

In the first aligning roller 41 illustrated in FIG. 4, the fitting protrusion portions 55 and 55 are fit into the fitting recess portions 56 and 56 of the second separated roller 52. In the sheet aligning mechanism of the embodiment, it is also possible to adopt a structure in which a fitting protrusion portion (fitting portion) formed on the second separated roller is fit into a fitting recess portion (fitted portion) of the first rotary shaft. That is, in the sheet aligning mechanism of the embodiment, a fitted portion may be formed on one of the second separated roller and the first rotary shaft, and a fitting portion may be formed on the other of the second separated roller and the first rotary shaft.

In the first aligning roller 41 illustrated in FIG. 3, the second separated rollers 52 are provided on one end side and the other end side of the first rotary shaft 45, two at each side, with respect to the first separated roller 51. In the sheet aligning mechanism of the embodiment may be provided with second separated rollers at one end side and the other end side of the first rotary shaft, three or more at each side, with respect to the first separated roller.

The first aligning roller 41 illustrated in FIG. 3 includes the plurality of separated rollers (the first separated roller 51 and the second separated rollers 52) which are separate members. In the sheet aligning mechanism of the embodiment, it may also adopt a structure in which an integrally-formed first aligning roller includes a first region and a second region as partial regions.

In the first aligning roller 41 illustrated in FIG. 3, the second separated rollers 52 are provided on one end side and the other end side of the first separated roller 51, respectively. However, in the first aligning roller, the second separated rollers may be provided only on one end side of the first separated roller.

The first aligning roller 41 illustrated in FIG. 3 includes the first separated roller 51 and the second separated rollers 52. However, one or more separated rollers (for example, third separated rollers) may be provided on the further end side compared to the second separated rollers. An outer circumferential surface of the third separated roller is a third region, and a friction coefficient of the third region is lower than the friction coefficient of the second region.

According to at least one embodiment described above, since the friction coefficient of the second region at the end side is lower than the friction coefficient of the first region, the sheet is more likely to slip. Accordingly, the sheet smoothly enters between the first aligning roller and the second aligning roller to collide with the nip. Therefore, it is possible to sufficiently correct the inclination of the sheet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet aligning mechanism comprising:
first and second aligning rollers that form a nip therebetween, to which a leading end of a sheet to be aligned is conveyed, wherein
the first aligning roller includes first and second roller portions along a rotational axis of the first aligning roller, the first roller portion including a center of the first aligning roller in an axial direction, and
a friction coefficient of a surface of the second roller portion is lower than a friction coefficient of a surface of the first roller portion.

2. The sheet aligning mechanism according to claim 1, wherein the first roller portion and the second roller portion are separated in the axial direction.

3. The sheet aligning mechanism according to claim 1, wherein the first roller portion and the second roller portion are contiguous in the axial direction.

4. The sheet aligning mechanism according to claim 1, wherein an outer diameter of the first roller portion is substantially equal to an outer diameter of the second roller portion.

5. The sheet aligning mechanism according to claim 1, wherein a width of the first roller portion in the axial direction is greater than a width of the second roller portion in the axial direction.

6. The sheet aligning mechanism according to claim 1, wherein the surface of the first roller portion is formed of rubber, and the surface of the second roller portion is formed of resin.

7. The sheet aligning mechanism according to claim 6, wherein the surface of the second roller portion is formed of polyacetal.

8. The sheet aligning mechanism according to claim 1, wherein
the first aligning roller further includes a third roller portion between the first roller portion and an end of the first aligning roller in the axial direction, and
a friction coefficient of a surface of the third roller portion is lower than the friction coefficient of the surface of the first roller portion.

9. The sheet aligning mechanism according to claim 8, wherein the friction coefficient of the surface of the second roller portion is equal to the friction coefficient of the surface of the third roller portion.

10. The sheet aligning mechanism according to claim 8, wherein the second roller portion and the third roller portion are symmetrically provided with respect to the first aligning roller in the axial direction.

11. The sheet aligning mechanism according to claim 8, wherein
the first aligning roller further includes a fourth roller portion between the second roller portion and another end of the first aligning roller in the axial direction, and a fifth roller portion between the third roller portion and the end of the first aligning roller in the axial direction, and
a friction coefficient of a surface each of the fourth and fifth roller portions is lower than the friction coefficient of the surface of the first roller portion.

12. The sheet aligning mechanism according to claim 1, wherein a surface of the second aligning roller is formed of metal.

13. The sheet aligning mechanism according to claim 1, wherein the first roller portion and the second roller portion are formed around a shaft, one of the second roller portion and the shaft including a protrusion that extends into the other of the second roller portion and the shaft.

14. The sheet aligning mechanism according to claim 1, wherein the second aligning roller is a driven roller that is driven in accordance with rotation of the first aligning roller.

15. An image forming apparatus comprising:
a printer; and
a sheet aligning device configured to align a sheet conveyed to the printer, wherein
the sheet aligning device includes:
first and second aligning rollers that form a nip therebetween, to which a leading end of the sheet to be aligned is conveyed, wherein
the first aligning roller includes first and second roller portions along a rotational axis of the first aligning roller, the first aligning roller portion including a center of the first aligning roller in an axial direction, and
a friction coefficient of a surface of the second roller portion is lower than a friction coefficient of a surface of the first roller portion.

16. The image forming apparatus according to claim 15, wherein the first roller portion and the second roller portion are separated in the axial direction.

17. The image forming apparatus according to claim 15, wherein the first roller portion and the second roller portion are contiguous in the axial direction.

18. An image forming apparatus comprising:
a printer; and
a sheet aligning device configured to align a sheet conveyed from the printer, wherein
the sheet aligning device includes:
first and second aligning rollers that form a nip therebetween, to which a leading end of the sheet to be aligned is conveyed, wherein
the first aligning roller includes first and second roller portions along a rotational axis of the first aligning roller, the first aligning roller portion including a center of the first aligning roller in an axial direction, and
a friction coefficient of a surface of the second roller portion is lower than a friction coefficient of a surface of the first roller portion.

19. The image forming apparatus according to claim 18, wherein the first roller portion and the second roller portion are separated in the axial direction.

20. The image forming apparatus according to claim 18, wherein the first roller portion and the second roller portion are contiguous in the axial direction.
